(19) United States
(12) Patent Application Publication
(10) Pub. No.: US 2010/0116177 A1
(43) Pub. Date: May 13, 2010

(54) TABLE

(76) Inventor: Robert Anthony YOUNG, West Dereham (PE)

Correspondence Address: DEFILLO & ASSOCIATES, INC., P.O. Box 14104, Clearwater, FL, 33766, US

(21) Appl. No.: 12/692,677

(22) Filed: Jan. 25, 2010

Related U.S. Application Data
(62) Division of application No. 11/641,996, filed on Dec. 19, 2006.

(51) Int. Cl. A01K 63/00; A47B 37/00; A01K 63/04

(52) U.S. Cl. 108/50.12; 119/247; 119/262

(57) ABSTRACT

A table comprise a tabletop with at least one portion suitable for over hanging at least a portion of a chair; at least one foot for carrying said tabletop; and an integral aquatic container.

### CROSS REFERENCE TO RELATED APPLICATION

This application is Divisional of Ser. No. 11/641,996 filed Dec. 19, 2006, entitled “A TABLE”.

### FIELD OF THE INVENTION

The invention relates to tables.

### BACKGROUND TO THE INVENTION

For many years ponds and tables have coexisted in gardens. The designs of ponds have evolved over the years to incorporate innovative shapes due in large part to advances in materials. These currently often include lighting, pumps, aeration and even filtration systems. Similarly, tables for outdoor use have been available in almost any shape or form and of almost any material from stone to plastics. Despite these numerous designs and constant improvements the combination of features of the invention has not been previously suggested.

### SUMMARY OF THE INVENTION

In its broadest independent aspect, the invention provides a table comprising a table top with at least one portion suitable for overhanging at least a portion of a chair, at least one foot for carrying said table top, and an integral aquatic container. This configuration is particularly advantageous because it allows ponds and tables to coexist in relatively confided spaces such as a small patio area of a garden. In addition, the table is particularly resistant to being toppled over by strong winds and therefore it neither needs to be anchored to the ground nor stowed away during high winds.

In a subsidiary aspect in accordance with the invention's broadest independent aspect, the table top incorporates an opening suitable for the insertion of a parasol; the table further comprises a channel and a drain; wherein the channel extends from said opening through the aquatic container to said drain. This configuration is particularly advantageous because it prevents the parasol mast particularly if it is wooden to be located in a relatively dry channel—thus preventing the parasol mast from rotting away. It also allows water, which maybe splashed from neighbouring aquatic containers into the channel to simply drain away without stagnating on the foot of the mast.

In a further subsidiary aspect, the tabletop incorporates at least one top opening of said aquatic container and a number of slats arranged around said opening. This provides a particularly stable structure, which may also be readily transported in the form of a kit.

In a further subsidiary aspect, when viewed in plan, the tabletop has a geometry shape with a number of sides and slats have extremities, which abut against a junction bracket, located between the sides of said tabletop. This configuration is particularly advantageous because it reduces the need to mitre the extremities of slats in order to simplify the assembly process of the table. It also allows the outer slats of the tabletop to be readily removed and then replaced if necessary. This is particularly advantageous when the table is provided in a part assembled form in order to be transported without the overhanging portions. The assembly of the overhanging portions is simplified by this feature.

In a further subsidiary aspect, the tabletop incorporates at least one top opening of said aquatic container and at least one lid for closing said at least one opening. This allows the contents of the aquatic container to be protected or for the table to be used to its full top surface extent without requiring extension pieces to be fitted to the overhanging portions of the table.

### BRIEF DESCRIPTION OF THE FIGURES

FIG. 1 shows a perspective view of a first embodiment of the table.

FIG. 2 shows a second embodiment of the table in perspective view.

FIGS. 3a and b show respectively a top view of the bracket junction between two sides of a tabletop and a perspective view of a bracket.

FIG. 4 shows a cross sectional view of the aquatic container equipped to channel and drain.

FIG. 5 shows an aquatic container compartment of a table in perspective view incorporating a further embodiment of a lid.

FIG. 6 is a perspective view of a table with an aquatic container in accordance with a further embodiment of the invention.

### DETAILED DESCRIPTION OF THE FIGURES

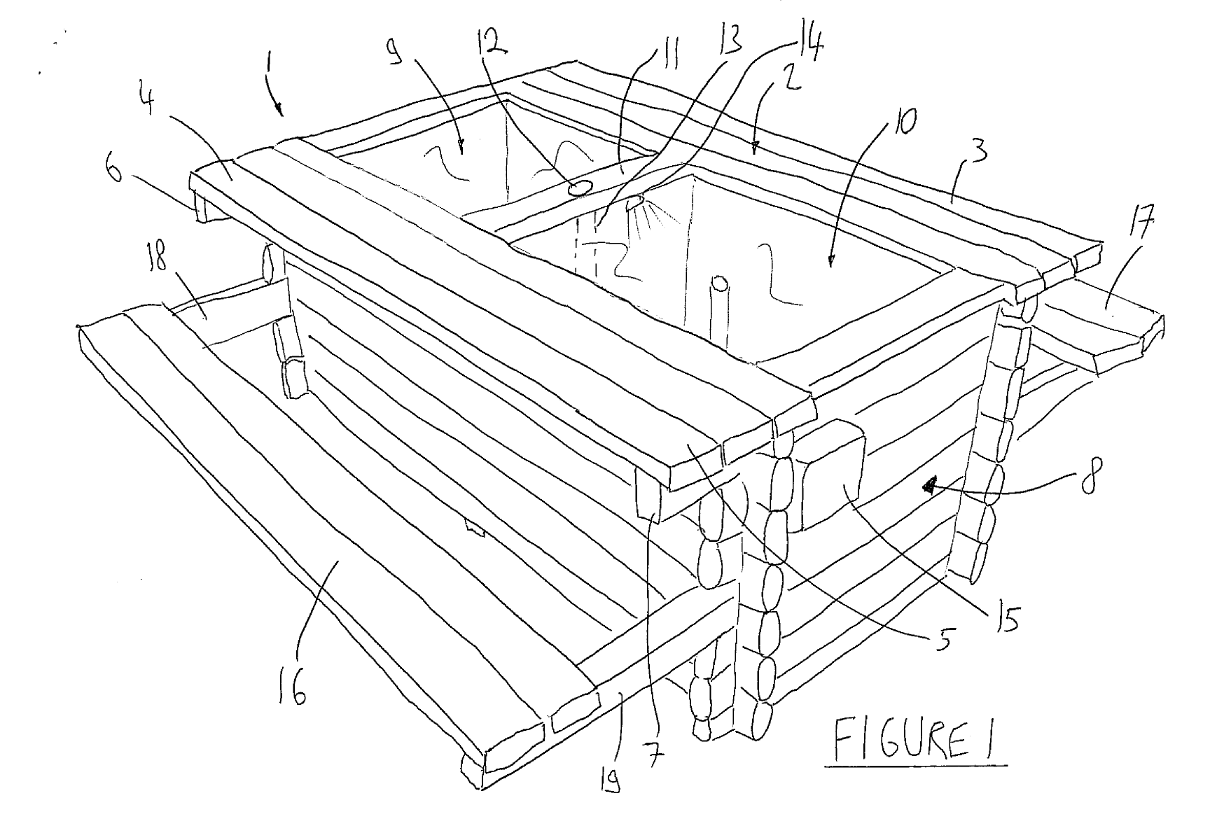

FIG. 1 shows a pond table or a table incorporating an aquatic table generally referenced 1. The table has a top 2 with two opposite overhanging portions 3 and 4, which respectively comprise three slats such as slat 5. The slats are supported by two beams 6 and 7 extending away from the pond table aquatic container portion generally referenced 8. Tabletop 2 has two aquatic container openings 9 and 10 through which the contents of the container can be seen. The walls of the aquatic container may be constituted of a black plastic sheet or portions of a moulded plastic box. The tabletop incorporates a cross piece 11 which extends from overhang portion 3 to overhang portion 4. Crosspiece 11 incorporates a bore 12 for the insertion of a parasol mast. Beneath the bore 12 there is connected a tube 13 traversing the entire depth of the aquatic container. The tube 13 may be joined to the base of the pond table in a watertight manner and incorporate at its lower most extremity an opening to allow water to drain away. In addition, a lighting unit 14 was attached to the crosspiece 11 in order to illuminate the contents of the aquatic container. In addition, an aerator, a pump and/or a filter are also envisaged. The pond table may be connected to mains power through power box 15.

Furthermore, the pond table incorporates oppositely located benches 16 and 17, which are attached to the central portion of the table via laterally extending beams such as beams 18 and 19.

Between the waterproof membrane, which contains the water of the pond table and its outer surface, it is envisaged optionally to incorporate an insulating layer to prevent heat loss from the pond table if for example the aquatic container is a heated pool. Furthermore, the aquatic container may be a single chamber with two upper openings as described above or may incorporate a partition underneath crosspiece 11 in order to incorporate two types of aquatic containers within a single pond table.

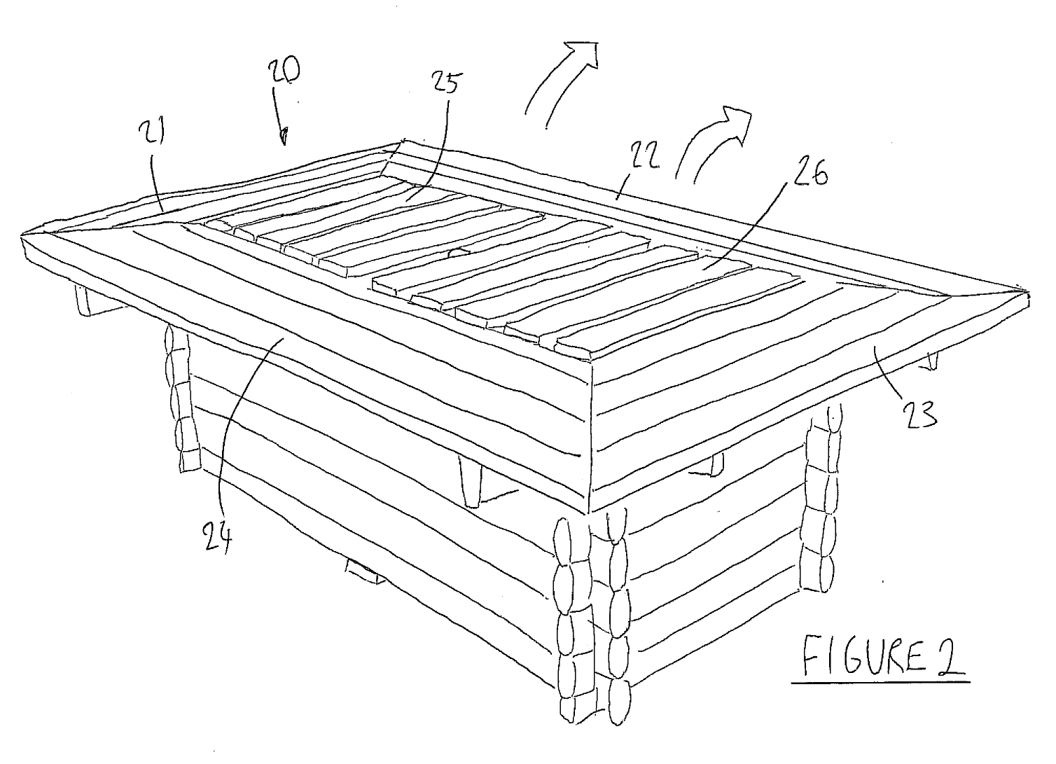

FIG. 2 shows a further pond table generally referenced 20 with 4 overhanging portions 21, 22, 23 and 24. The extremities of the slats which, constitute the overhanging portions, are mitred in order to abut against neighbouring extremities. The pond table shown incorporates two lids 25 and 26. These incorporate five upper slats, which are joined together by crosspieces. The lids are oversized when compared to their respective openings in order to fit on top of the inner most portions of the overhanging portions. The invention also envisages the incorporation of abutments inside the openings in order to allow the lids to sit flush with the rest of the table top.

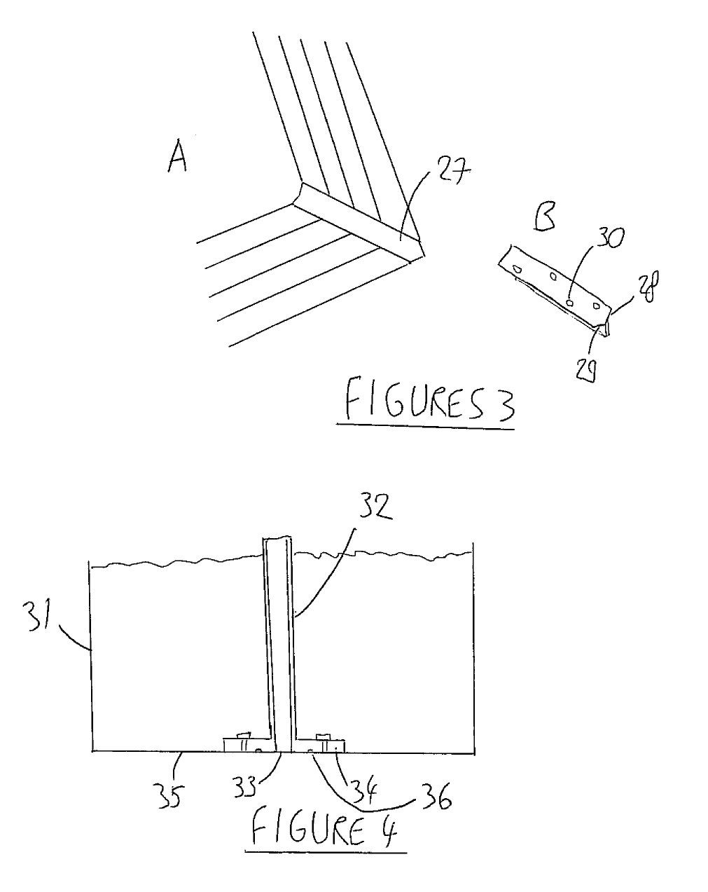

FIG. 3a shows the junction between two sides of a tabletop, which incorporate a plurality of slats. Bracket 27 is employed between neighbouring extremities of slats. For example, the bracket may be T-shaped in cross-section as shown in FIG. 3b with the two overhanging upper portions 28 and 29 in order to cover the extremities of the slats. This avoids or at least limits the requirement to mitre the extremities of slats. This also simplifies the installation of the slats. In addition, the bracket may have a number of bores such as bore 30 through which a screw or other appropriate attachment means may be used to attach the bracket to the extremities of the slats.

FIG. 4 shows an aquatic container 31 and a tube 32 which is sized and shaped to receive the mast of a parasol. The lower extremity 33 of the tube is open to allow any water located within the tube to drain out. At its lowest extremity the tube also incorporates a flange 34, which creates a watertight junction with the base 35 of the aquatic container. The watertight junction may be achieved by tightening flange 34 against base 35 and employing an O-ring 36.

FIG. 5 shows an aquatic container of the kind, which might be used in a square pond table. Aquatic container 37 incorporates a lid 40, which engages vertical troughs 38 and 39, so that the lid may be joined throughout its use to the aquatic container. Lid 40 has two projecting axels 41 and 42 which are sized and shaped to slot into the troughs.

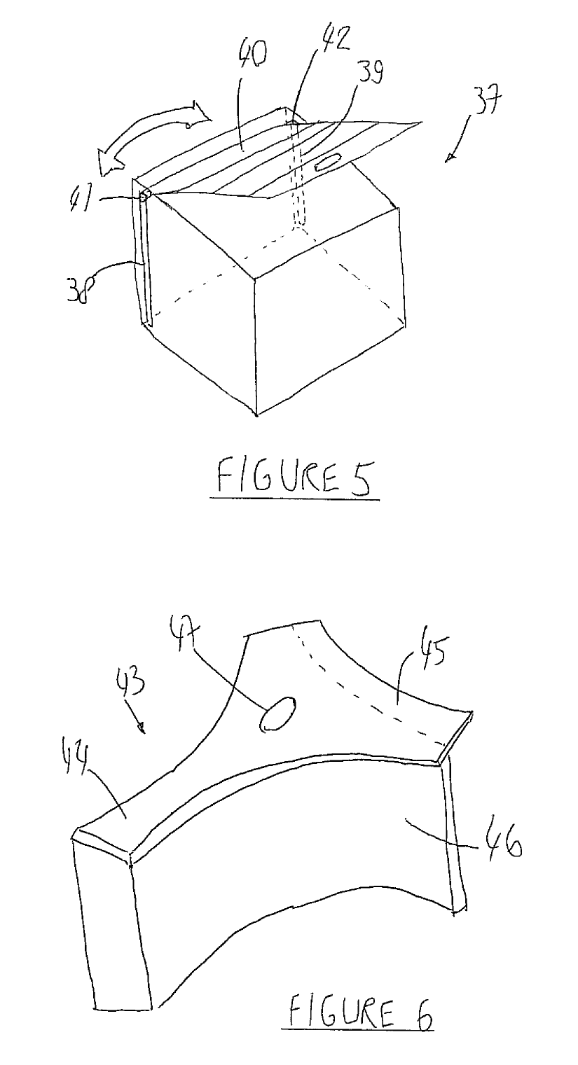

FIG. 6 shows a table 43 with a tabletop 44 incorporating an overhanging portion 45 and an aquatic container 46 which may have see-through sides such as those used in aquaria. Similarly to the previous embodiments, the tabletop may incorporate a parasol mast channel 47.

The scope of the invention is defined in the claims which now follow.

1-5. (canceled)

6. A pond table comprising:
a table top;
at least one foot for carrying said table top;
an integral thermally insulated watertight container; and
at least one of an aerator, a pump, a filter and a heater;
wherein the container is suitable for maintaining aquatic life in an outdoor environment, and wherein the table top incorporates at least one top opening of said container for viewing aquatic life in the container.

7. The pond table according to claim 6, further comprising a parasol holder, the parasol holder comprising a tube extending from said opening through the container, the tube defining an enclosed channel suitable for the insertion of a parasol mast therein; and wherein the tube includes a drain for draining of liquid from the tube.

8. The pond table according to claim 6, wherein the table top incorporates a number of slats arranged around said opening.

9. A pond table according to claim 6, wherein the table top incorporates at least one lid for closing said at least one opening so as to provide an extended dining surface for said table and/or to protect aquatic life in the container.

10. A pond table according to claim 6, comprising an aerator, a pump, a filter and a heater.

11. A pond table according to claim 6, further comprising at least one integral seat arranged around the table top.

12. A pond table according to claim 6, wherein the table top includes at least one portion suitable for overhanging at least a portion of a chair.

13. A pond table according to claim 6, having two openings.

14. A pond table according to claim 6, wherein the thermally insulated watertight container comprises a moulded plastic box.

15. A pond table according to claim 7, wherein the parasol holder comprises a cross piece that extends over the opening and that channel and is provided with a bore in alignment with the channel for insertion of the parasol mast there through.

16. A pond table according to claim 7, wherein the container has a base and the tube extends from the opening through the container and is connected to the base of the container by a watertight junction.

17. A pond table according to claim 6, further comprising a second integral thermally insulated watertight container for maintaining aquatic life in an outdoor environment.

18. A kit comprising parts for the assembly of the pond table of claim 6 and instructions for assembly.
